(19) United States
(12) Patent Application Publication
(10) Pub. No.: US 2026/0285340 A1
(43) Pub. Date: Sep. 24, 2026

(54) System and Method for Operating Vehicle Functions

(71) Applicant: Bayerische Motoren Werke Aktiengesellschaft, Muenchen (DE)

(72) Inventor: Andreas SPAETH, Lindau (DE)

(21) Appl. No.: 19/476,222

(22) PCT Filed: May 16, 2024
(86) PCT No.: PCT/EP2024/063520

§ 371 Date: Oct. 17, 2025

(30) Foreign Application Priority Data
May 25, 2023 (DE) 10 2023 113 831.6

(51) Int. Cl. B60W 50/08; B60W 50/14; G06F 8/65

(52) U.S. Cl. CPC B60W 50/085; B60W 50/14; G06F 8/65

(57) ABSTRACT

A system for operating vehicle functions, comprising a user interface module to receive a first user input for deactivating a vehicle function. In response to the receipt of the first user input, the user interface module outputs a first feedback request to the user for reasons for deactivating the vehicle function, and receives a second user input for responding to the first feedback request. A vehicle-side function module receives a software update for the vehicle function comprising change information relating to changes to the vehicle function. The system compares the change information with the reasons for deactivating the vehicle function received by the second user input. The user interface module outputs a user indication relating to the software update if the comparison reveals that the reasons for deactivation of the vehicle function indicated by the second user input.

### BACKGROUND AND SUMMARY

The present disclosure relates to a system for operating vehicle functions, a vehicle having such a system, and a method for operating vehicle functions. The present disclosure in particular relates to improving vehicle functions based on user feedback and in consideration of data-protection specifications.

### PRIOR ART

A large number of vehicle functions are currently present in modern vehicles, which can assist a user, for example, in the vehicle control or are to create a pleasant environment or a pleasant driving experience. However, such vehicle functions are not matched to all situations, countries, personal preferences and user behaviors. It is therefore often provided that the user can deactivate certain vehicle functions in a menu. However, deactivating driver assistance functions, for example, can have a negative effect on safety in road traffic, since the driver assistance functions often offer greater safety in comparison to solely manual driving.

### SUMMARY OF DISCLOSURE

It is an object of the present disclosure to specify a system for operating vehicle functions, a vehicle having such a system, and a method for operating vehicle functions which enable improvement of vehicle functions to prompt a user to use the vehicle functions. In particular, it is an object of the present disclosure not to give a user any further reason to deactivate vehicle functions and therefore to enhance safety in road traffic.

According to one independent aspect of the present disclosure, a system for operating vehicle functions is specified. The system comprises a user interface module configured to receive at least one first user input for deactivating a vehicle function, wherein the user interface module is furthermore configured, upon receiving the at least one first user input, to output at least one first feedback query on reasons for the deactivation of the vehicle function to the user, and wherein the user interface module is furthermore configured to receive at least one second user input to respond to the at least one first feedback query; and a vehicle-side functional module configured to receive a software update for the vehicle function, wherein the software update comprises modification information with respect to modifications of the vehicle function.

The system, in particular the functional module, is furthermore configured to compare the modification information to the reasons received due to the at least one second user input for deactivating the vehicle function, and wherein the user interface module is furthermore configured to output at least one user notification with respect to the software update if the comparison shows that the software update relates to (or solves or eliminates) the reasons for deactivating the vehicle function indicated by the at least one second user input.

According to the disclosure, reasons for a user-side deactivation of a vehicle function are queried and stored in the vehicle. Optionally, the reasons can be transmitted in anonymized form to a central unit so that, for example, developers of the vehicle function can take these into consideration in the preparation of a software update. If a software update is now downloaded to the vehicle for the vehicle function, the vehicle checks whether the software update relates to the reasons for the deactivation of the vehicle function or eliminates them. If this is the case, a corresponding user notification is output to the user in order to prompt the user to reactivate the vehicle function. The comparison of the software update to the reasons for the deactivation takes place in the vehicle so that no data relevant to data protection, such as an identity of the user and/or a VIN of the vehicle, has to be transmitted externally, for example, to the developers.

The functional module is preferably configured to execute the software update, wherein the user interface module is configured to output at least one second feedback query on the software update of the vehicle function to the user after executing the software update, and wherein the user interface module is furthermore configured to receive at least one third user input to respond to the at least one second feedback query. It can thus be checked after the installation of the software update whether the earlier reasons for deactivating the vehicle function still exist or were eliminated by the software update.

Furthermore, the system preferably comprises a vehicle-side communication module configured to transmit information with respect to the at least one second user input for responding to the at least one first feedback query to the central unit. Moreover, the communication module can be configured to transmit information with respect to the at least one third user input for responding to the at least one second feedback query to the central unit.

The communication module can be configured for communication via a mobile network. In particular, the communication between the vehicle-side communication module and the central unit can take place via the mobile network, such as an LTE network or 5G network.

In some embodiments, the central unit is a server or backend, for example, of a vehicle producer. The central unit can provide the received information with respect to the deactivation of the vehicle function in anonymized form to developers of the vehicle function, for example, so that the developers can take this information into consideration in the preparation of the software update for the vehicle function.

The system preferably furthermore comprises a vehicle-side storage module, which is configured to store vehicle-related data, wherein the communication module is furthermore configured to transmit at least a part of the vehicle-related data from a predetermined period of time (for example, x seconds or y minutes) around a time of the deactivation of the vehicle function to the central unit. The vehicle-related data can relate to operating the vehicle and/or operating the vehicle function and/or the vehicle surroundings. The vehicle-related data can enable a driving situation at the time of the deactivation to be reconstructed. Solutions to avoid a deactivation of the vehicle function in future, for example, in similar driving situations, can thus be derived more easily.

In some embodiments, the storage module comprises or is a ring memory or ring buffer.

Alternatively, the storage module can be connected to the ring memory or ring buffer and can receive and store the vehicle-related data from the predetermined period of time (for example, x seconds or y minutes) around the time of the deactivation of the vehicle function from the ring memory. In this way, it is possible to avoid relevant data no longer being available later, since they were overwritten in the ring memory after some time.

The user interface module is preferably configured to provide, in the context of the at least one first feedback query, a plurality of individual reasons with respect to the deactivation of the vehicle function, wherein the individual reasons are selectable individually by the at least one second user input. Additionally or alternatively, the user interface module can be configured to provide a free text input with respect to the deactivation of the vehicle function.

Similarly, the user interface module can be configured to provide, in the context of the at least one second feedback query, a plurality of individual points with respect to the software update of the vehicle function, wherein the individual points are selectable individually by the at least one third user input. Additionally or alternatively, the user interface module can be configured to provide a free text input with respect to the software update of the vehicle function.

The user interface module is preferably implemented in a mobile terminal of the user. For example, an app can be installed on the mobile terminal, which enables activation and deactivation of vehicle functions and optionally the feedback function according to the disclosure. In some embodiments, the user interface module comprises or is a touchscreen of the mobile terminal.

The term mobile terminal includes in particular smartphones, but also other mobile telephones or cellular telephones, personal digital assistants (PDAs), tablet PCs, and all routine and future electronic devices which are equipped with a technology for loading and executing apps.

Alternatively, the user interface module can be implemented in the vehicle, and in particular can be permanently installed in the vehicle.

The user interface module provided in the vehicle can comprise at least one output device and at least one input device. The user interface module can be, for example, a central information output and information input device of an infotainment system, such as a head unit or a pillar-to-pillar display.

The at least one output device can comprise at least one display device and/or at least one loudspeaker. The at least one display device can comprise a display, in particular an LCD display, a plasma display, or an OLED display. Additionally or alternatively, the at least one display device can comprise a projection device configured to show information directly in the field of view of the driver, in particular to project it on a windshield.

The at least one input device can comprise a touch sensitive input device, such as a touch panel or touchpad, and/or a tactile input device, such as a switch (for example, pushbutton and/or rotating switch), or other mechanically operable button elements.

The user interface module preferably comprises or is a touchscreen which provides the at least one output device and the at least one input device.

The vehicle function preferably comprises a driver assistance function and/or a comfort function of the vehicle.

Exemplary driver assistance functions comprise, but are not limited to, driver assistance functions for automated driving. Exemplary comfort functions comprise, but are not limited to, interior lighting, an entertainment system, and automatic opening mechanisms, for example, of vehicle doors and/or windows.

The term “automated driving” is understood in the context of the document as driving using automatic longitudinal and/or lateral guidance. Automated driving can involve, for example, driving for longer time on the freeway or driving for limited time in the context of parking. The term “automated driving” comprises automated driving with an arbitrary degree of automation. Exemplary degrees of automation are assisted, semiautomated, conditionally automated, highly automated, and fully automated driving (with increasing degree of automation in each case). The above-mentioned five degrees of automation correspond to SAE levels 1 to 5 of the norm SAE J3016 (SAE-Society of automotive engineering) according to the version of 30 Apr. 2021.

In assisted driving (SAE level 1) the system carries out the longitudinal or lateral guidance in specific driving situations. In semiautomated driving (SAE level 2) the system takes over the longitudinal and lateral guidance in specific driving situations, wherein the driver has to continuously monitor the system as in assisted driving. In conditionally automated driving (SAE level 3) the system takes over the longitudinal and lateral guidance in specific driving situations without the driver having to continuously monitor the system; however, the driver has to be capable within a specific time of taking over the vehicle guidance upon request by the system. In highly automated driving (SAE level 4) the system takes over the vehicle guidance in specific driving situations, even if the driver does not react to a request to intervene, so that the driver is dispensed with as a fallback level. In fully automated driving (SAE level 5), all aspects of the dynamic driving task can be carried out by the system under any roadway and environmental conditions which are also managed by a human driver.

In addition, the term “at least semiautomated driving or maneuvering” is also understood in the context of the document as semiautomated, conditionally automated, highly automated, or fully automated driving. In other words, a degree of automation from SAE level 2 inclusive is understood under the term “at least semiautomated driving”.

The driver assistance function is preferably an active lane change assistant configured for automated lateral guidance and optionally automated longitudinal guidance of the vehicle. The vehicle comprises in some embodiments an actuating element for a directional indicator, wherein the actuating element can be configured to carry out the lane change in an automated manner when it is actuated or triggered by the driver. The actuating element can be a turn signal lever here and can have a multiple function, namely activating the directional indicator and triggering the automatic overtaking maneuver.

According to a further independent aspect of the present disclosure, a vehicle, in particular a motor vehicle, is specified. The vehicle comprises at least part of the system for operating vehicle functions according to the embodiments of the present disclosure.

The term vehicle comprises passenger vehicles, trucks, buses, caravans, motorcycles, etc. used to convey people, goods, etc. In particular, the term comprises motor vehicles for conveying people.

The vehicle preferably comprises the complete system, thus the user interface module and the functional module and optionally the communication module and the storage module.

In other embodiments, the vehicle comprises the functional module and optionally the communication module and the storage module. The user interface module can be a vehicle-external module, such as a mobile terminal of the user. The mobile terminal can be connected, for example, via Bluetooth or another near-field technology to the vehicle in order to implement the functionalities of the embodiments of the present disclosure.

According to a further independent aspect of the present disclosure, a method for operating vehicle functions is specified. The method comprises receiving, by a user interface module, at least one first user input for deactivating a vehicle function; outputting, by the user interface module, at least one first feedback query on reasons for the deactivation of the vehicle function to the user upon receiving the at least one first user input; receiving, by the user interface module, at least one second user input to respond to the at least one first feedback query; receiving, by a vehicle-side functional module, a software update for the vehicle function, wherein the software update comprises modification information with respect to modifications of the vehicle function; comparing, by the functional module, the modification information to the reasons obtained by the at least one second user input for deactivating the vehicle function; and outputting, by the user interface module, at least one user notification with respect to the software update if the comparison shows that the software update relates to (or solves or eliminates) the reasons indicated by the at least one second user input for deactivating the vehicle function.

The method can implement the aspects of the system for operating vehicle functions described in this document.

According to a further independent aspect of the present disclosure, a software (SW) program is specified. The SW program can be configured to be executed on one or more processors and thus to carry out the method described in this document for operating vehicle functions.

According to a further independent aspect of the present disclosure, a storage medium is specified. The storage medium can comprise an SW program which is configured to be executed on one or more processors and thus to carry out the method described in this document for operating vehicle functions.

According to a further independent aspect of the present disclosure, software having program code is specified. The software is configured to carry out the method for operating vehicle functions when the software runs on one or more software-controlled devices.

According to a further independent aspect of the present disclosure, a system for operating vehicle functions is specified. The system comprises one or more processors; and at least one memory, which is connected to the one or more processors and contains instructions which can be executed by the one or more processors in order to carry out the method described in this document for operating vehicle functions.

A processor or a processor module is a programmable computing mechanism, thus a machine or an electronic circuit which controls other elements according to transferred commands and advances an algorithm (process) in this case.

### BRIEF DESCRIPTION OF THE DRAWINGS

FIG. 1 schematically shows a system for operating vehicle functions according to embodiments of the present disclosure;

FIG. 2A schematically shows an output of feedback queries according to embodiments of the present disclosure;

FIG. 2B schematically shows an output of a user notification with respect to a software update according to embodiments of the present disclosure; and,

FIG. 3 shows a flow chart of a method for operating vehicle functions according to embodiments of the present disclosure.

### DETAILED DESCRIPTION OF THE DRAWINGS

Identical reference signs are used hereinafter, if not indicated otherwise, for identical and identically-acting elements.

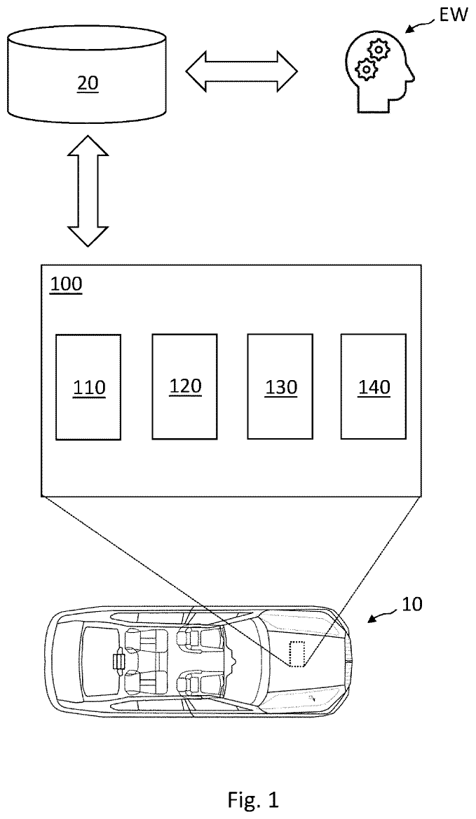

FIG. 1 schematically shows a system 100 for operating vehicle functions according to embodiments of the present disclosure.

The system 100 comprises a user interface module 110 configured to receive at least one first user input to deactivate a vehicle function, wherein the user interface module 110 is furthermore configured, upon receiving the at least one first user input, to output at least one first feedback query on reasons for the deactivation of the vehicle function to the user, and wherein the user interface module 110 is furthermore configured to receive at least one second user input to respond to the at least one first feedback query; and a vehicle-side functional module 120, which is configured to receive a software update for the vehicle function, wherein the software update comprises modification information with respect to modifications of the vehicle function.

The system 100, in particular the functional module 120, is furthermore configured to compare the modification information to the reasons obtained by the at least one second user input for the deactivation of the vehicle function, and wherein the user interface module 110 is furthermore configured to output at least one user notification with respect to the software update if the comparison shows that the software update relates to (or solves or eliminates) the reasons for the deactivation of the vehicle function indicated with the at least one second user input.

The system 100 can therefore be continually optimized on the basis of real complaints. The user is part of the development and therefore feels taken seriously and has a positive experience due to the optimized system 100.

The functional module 120 is preferably configured to execute the software update, wherein the user interface module 110 is configured, after executing the software update, to output at least one second feedback query on the software update of the vehicle function to the user, and wherein the user interface module 110 is furthermore configured to receive at least one third user input to respond to the at least one second feedback query. Therefore, it can be checked after installation of the software update whether the earlier reasons for the deactivation of the vehicle function still exist or were eliminated by the software update.

In some embodiments, the system 100 furthermore comprises a vehicle-side communication module 130, which is configured to transmit information with respect to the at least one second user input to respond to the at least one first feedback query to a central unit 20. Moreover, the communication module 130 can be configured to transmit information with respect to the at least one third user input to respond to the at least one second feedback query to the central unit 20.

The communication module 130 can be configured for communication via a mobile network. In particular, the communication between the vehicle-side communication module 130 and the central unit 20 can take place via the mobile network, such as an LTE network or 5G network.

In some embodiments, the central unit 20 is a server or backend, for example, of a vehicle producer. The central unit 20 can provide the received information with respect to the deactivation of the vehicle function in anonymized form to, for example, developers EW of the vehicle function, so that the developers EW can take this information into consideration when preparing the software update for the vehicle function.

The central unit 20 can moreover be configured to transfer the software update to the vehicle 10. This can take place, for example, via the mobile network, such as an LTE network or 5G network.

The system 100 preferably furthermore comprises a vehicle-side storage module 140, which is configured to store vehicle-related data, wherein the communication module 130 is furthermore configured to transmit at least a part of the vehicle-related data from a predetermined period of time (for example, x seconds or y minutes) around a time of the deactivation of the vehicle function to the central unit 20. The vehicle-related data can relate to operation of the vehicle 10 and/or operation of the vehicle function and/or the vehicle surroundings. The vehicle-related data can enable a driving situation at the time of the deactivation to be reconstructed. Solutions to avoid a deactivation of the vehicle function in future, for example, in similar driving situations can therefore be derived more easily.

In some embodiments, the storage module 140 comprises or is a ring memory or ring buffer. Alternatively, the storage module 140 can be connected to the ring memory or ring buffer and can receive and store the vehicle-related data from the predetermined period of time (for example, x seconds or y minutes) around the time of the deactivation of the vehicle function from the ring memory. In this way, it is possible to avoid relevant data no longer being available later, since they were overwritten in the ring memory after some time.

In the example of FIG. 1, the user interface module 110 is installed in the vehicle 10. However, the present disclosure is not restricted thereto and the user interface module can be provided in other embodiments, for example, by a mobile terminal of the user. For example, an app can be installed on the mobile terminal which enables activation and deactivation of vehicle functions and optionally the feedback function according to the disclosure. In some embodiments, the user interface module comprises or is a touchscreen of the mobile terminal.

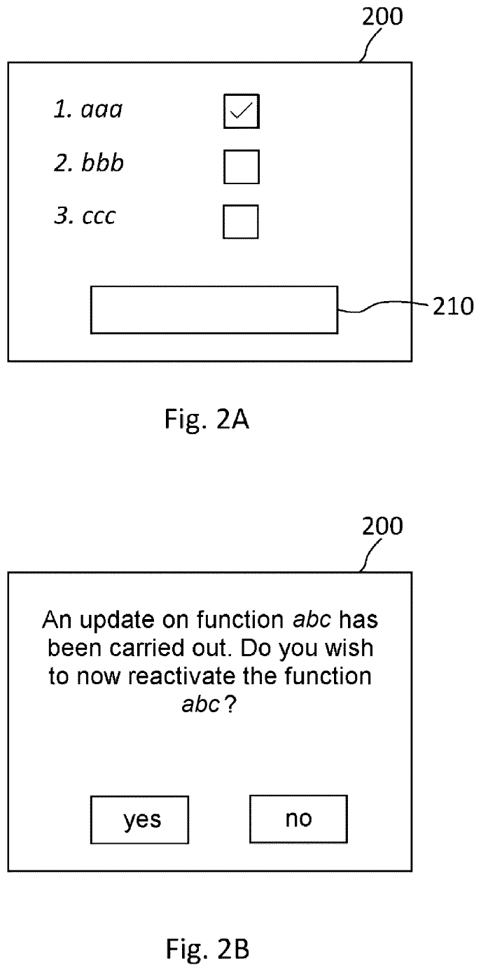

FIG. 2A schematically shows an output of feedback queries according to embodiments of the present disclosure. The feedback queries can be output acoustically and/or optically. In the example of FIG. 2A, a user interface module is shown which outputs the feedback queries optically on a display 200 thereof.

The user interface module is configured, upon receiving the at least one first user input for deactivating the vehicle function, to output at least one first feedback query on reasons for the deactivation of the vehicle function to the user. The user interface module is furthermore configured to receive at least one second user input to respond to the at least one first feedback query.

The user interface module is preferably configured to provide a plurality of individual reasons with respect to the deactivation of the vehicle function in the context of the at least one first feedback query, wherein the individual reasons are individually selectable by the at least one second user input. In the example of FIG. 2A, three individual reasons 1-3 are shown, which can each be selected by actuating a check box. Only the first individual reason is selected in FIG. 2A. The individual reasons can correspond to specified criteria, such as excessively many steering actions of a lane guidance function, incorrect braking operations of ACC, automatic start/stop mechanism, etc.

Additionally or alternatively, the user interface module can be configured to provide a free text input 210 with respect to the deactivation of the vehicle function.

FIG. 2B schematically shows an output of a user notification with respect to a software update according to embodiments of the present disclosure. The user notification can be output acoustically and/or optically. The example of FIG. 2B shows a user interface module which optically outputs the user notification on a display 200 thereof.

The user interface module is configured to output at least one user notification with respect to the software update if the software update addresses the reasons specified using the at least one second user input for the deactivation of the vehicle function.

For example, a software update can be ready via remote software upgrade which contains optimizations for the behavior “X” for function “Y”, to which the user objected. In suitable surroundings (for example, during a journey on an empty freeway with good weather and little stress for the driver), the user notification about the improved function can be communicated. In this case, in some embodiments it can be made possible for the user to reactivate the optimized function “Y” directly via speech, button, or another possible input, as shown in the example of FIG. 2B.

Moreover, it is possible that the user receives a renewed dialogue, for example, via a speech assistant or via text display in the HMI, after a certain usage of the optimized function “Y”, so that the user can indicate whether the function “Y” now operates satisfactorily. Predefined selection options and/or a free text are also again conceivable here, similarly as shown in FIG. 2A. Using such updated feedback, at least one further optimization loop can take place once again until the user is satisfied and negative feedback no longer takes place.

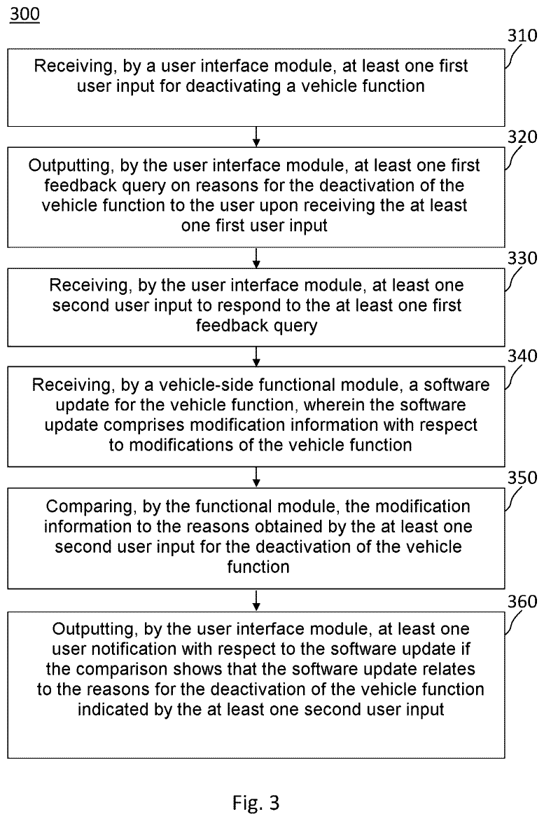

FIG. 3 shows a flow chart of a method 300 for operating vehicle functions according to embodiments of the present disclosure. The method 300 can be implemented by corresponding software which is executable by one or more processors (such as a CPU).

The method 300 comprises, in block 310, receiving by a user interface module at least one first user input for deactivating a vehicle function; in block 320, outputting by the user interface module at least one first feedback query on reasons for the deactivation of the vehicle function to the user upon receiving the at least one first user input; in block 330, receiving by the user interface module at least one second user input to respond to the at least one first feedback query; in block 340 receiving by a vehicle-side functional module a software update for the vehicle function, wherein the software update comprises modification information with respect to modifications of the vehicle function; in block 350, comparing by the functional module the modification information to the reasons obtained by the at least one second user input for the deactivation of the vehicle function; and in block 360, outputting by the user interface module at least one user notification with respect to the software update if the comparison shows that the software update relates to (or solves or eliminates) the reasons for the deactivation of the vehicle function indicated by the at least one second user input.

In one example, a lane change assistant can be activated and deactivated by a user in a user interface (such as HMI). It is now assumed that the user travels with activated lane change assistant and actuates the turn signal lever to trigger the lane change assistant. The user can now deactivate the lane change assistant in the HMI, for example, since the user is of the opinion that the lane change assistant has repeatedly carried out the lane change for this traffic situation excessively non-dynamically. Upon the deactivation, a running ring buffer having adequate leading and trailing time can be stored in order to be able to comprehend the driving situation in a later analysis. In a suitable situation, the user can be queried via HMI (speech and/or text) with respect to the reason for deactivation. As soon as a software update for this complaint is available, the user can be informed about the optimization which has taken place and the function can be activated again on his request. The user now experiences the function optimized by his feedback.

According to the disclosure, reasons for a user-side deactivation of a vehicle function are queried and stored in the vehicle. Optionally, the reasons can be transferred in anonymized form to a central unit so that, for example, developers of the vehicle function can take them into consideration in the preparation of a software update. If a software update is now downloaded into the vehicle for the vehicle function, the vehicle checks whether the software update deals with the reasons for the deactivation of the vehicle function or eliminates them. If this is the case, a corresponding user notification is output to the user in order to prompt the user to reactivate the vehicle function. The comparison of the software update to the reasons for the deactivation takes place in the vehicle, so that no data relevant to data protection, such as an identity of the user and/or a VIN of the vehicle, has to be sent to an external location, for example, to the developers.

Although the disclosure is illustrated and explained in more detail by preferred exemplary embodiments, the disclosure is not thus restricted by the disclosed examples and other variations can be derived therefrom by a person skilled in the art without departing from the scope of protection of the disclosure. It is therefore clear that a variety of possible variations exist. It is likewise clear that embodiments mentioned as examples actually only represent examples, which are not to be interpreted in any way as a limitation, for example, of the scope of protection, the possible applications, or the configuration of the disclosure. Rather, the preceding description and the description of the figures make a person skilled in the art capable of specifically implementing the exemplary embodiments, wherein a person skilled in the art who is aware of the disclosed concept of the disclosure can perform manifold modifications, for example, with respect to the function or the arrangement of individual elements mentioned in an exemplary embodiment without departing from the scope of protection defined by the claims and their legal equivalents, such as more extensive explanations in the description.

1.-10. (canceled)

11. A system for operating vehicle functions, comprising:
a user interface module configured to receive at least one first user input for deactivating a vehicle function, wherein the user interface module is furthermore configured, upon receiving the at least one first user input, to output at least one first feedback query on reasons for the deactivation of the vehicle function to the user, and wherein the user interface module is furthermore configured to receive at least one second user input to respond to the at least one first feedback query; and
a vehicle-side functional module, which is configured to receive a software update for the vehicle function, wherein the software update comprises modification information with respect to modifications of the vehicle function,
wherein the system is furthermore configured to compare the modification information to the reasons received by the at least one second user input for the deactivation of the vehicle function, and wherein the user interface module is furthermore configured to output at least one user notification with respect to the software update if the comparison shows that the software update relates to the reasons specified using the at least one second user input for the deactivation of the vehicle function.

12. The system according to claim 11, wherein the functional module is configured to execute the software update, and wherein the user interface module is configured, after the execution of the software update, to output at least one second feedback query on the software update of the vehicle function to the user, and wherein the user interface module is furthermore configured to receive at least one third user input to respond to the at least one second feedback query.

13. The system according to claim 11, furthermore comprising a vehicle-side communication module, which is configured to transmit information with respect to the at least one second user input to respond to the at least one first feedback query to a central unit, in particular wherein the communication module is furthermore configured to transmit information with respect to the at least one third user input to respond to the at least one second feedback query to the central unit.

14. The system according to claim 12, furthermore comprising a vehicle-side storage module, which is configured to store vehicle-related data, wherein the communication module is furthermore configured to transmit at least a part of the vehicle-related data from a predetermined period of time around a time of the deactivation of the vehicle function to the central unit.

15. The system according to claim 11, wherein the user interface module is configured:
to provide a plurality of individual reasons with respect to the deactivation of the vehicle function, wherein the individual reasons are individually selectable by the at least one second user input; and/or
to provide a free text input with respect to the deactivation of the vehicle function.

16. The system according to claim 11, wherein the vehicle function comprises a driver assistance function and/or a comfort function of the vehicle.

17. The system according to claim 11, wherein:
the user interface module is implemented in a mobile terminal; or
the user interface module is implemented in the vehicle.

18. A vehicle, comprising the system according to claim 11.

19. A method for operating vehicle functions, comprising:
receiving, by a user interface module, at least one first user input to deactivate a vehicle function;
outputting, by the user interface module, at least one first feedback query on reasons for the deactivation of the vehicle function to the user upon receiving the at least one first user input;
receiving, by the user interface module, at least one second user input to respond to the at least one first feedback query;
receiving, by a vehicle-side functional module, a software update for the vehicle function, wherein the software update comprises modification information with respect to modifications of the vehicle function;
comparing, by the functional module, the modification information to the reasons obtained by the at least one second user input for the deactivation of the vehicle function; and
outputting, by the user interface module, at least one user notification with respect to the software update if the comparison shows that the software update relates to the reasons indicated using the at least one second user input for the deactivation of the vehicle function.

20. A storage medium comprising a software program configured to be executed on one or more processors and to thus carry out the method according to claim 19.
